(19) United States
(12) Patent Application Publication
(10) Pub. No.: US 2005/0177592 A1
(43) Pub. Date: Aug. 11, 2005

(54) SYSTEM FOR SEARCHING FOR DATA AND DEFINING DATA IN TREE STRUCTURES AND METHOD OF SEARCHING AND DEFINING DATA IN TREE STRUCTURES

(75) Inventor: Kamil BURZYNSKI, Zielona Gora (PL)

Correspondence Address: SCHOLL PATENT AGENCY, INC.;DR. MATTHIAS SCHOLL, 14781 MEMORIAL DRIVE, SUITE 1319, HOUSTON, TX, 77079, US

(73) Assignees: ADVANCED DIGITAL BROADCAST LTD., Hsin-Tien City (TW); ADVANCED DIGITAL BROADCAST POLSKA SP. Z O.O., Zielona Gora (PL)

(21) Appl. No.: 10/904,448

(22) Filed: Nov. 10, 2004

(30) Foreign Application Priority Data
Nov. 12, 2003 (PL) P-363397

(51) Int. Cl. G06F 17/00

(52) U.S. Cl. 707/102

(57) ABSTRACT

The present invention relates to a system of searching and defining data in tree structures. The system includes a block of analysis of data structure (2), in which the data structure, which is created by data sources (1) connected to the block of data structure analysis (2), is analyzed and also in this block the database is created. The system also includes a data searching block, which searches data according to users criteria. The found data create a database of the output data structure (3), which is updated in the data update block (5) according to queries, defined in the output structure. The data from the output database are passed to the data output (8), while the unit, controlling the operation of the system is a control computer (6), which is operated by the user (7).

### CROSS-REFERENCE TO RELATED APPLICATIONS

This application claims priority to Polish Application No. P-363397, filed Nov. 12, 2003, the contents of which are incorporated herein by reference.

### BACKGROUND OF THE INVENTION

1. Field of the Invention

The present invention relates to a system for searching and defining data in tree structures and a method of searching and defining data in tree structures.

2. Brief Description of the Background of the Invention Including Prior Art

In many cases during processing of digital television data streams a situation happens when much information must be gathered, which is scattered in many components of given data streams. For example identification numbers of each service from a given stream or identification numbers of all streams, which belong to a given network.

There is SQL language known from the state of the art, which is called so from the abbreviation of words Structured Query Language, which is applicable in relational databases. Data in such databases are stored in tables, which can be connected between each other by means of relations.

### SUMMARY OF THE INVENTION

### PURPOSES OF THE INVENTION

It is an object of the present invention to provide a method of searching for specific data in television streams and a mechanism of performing database queries for tree structures.

This and other objects and advantages of the present invention will become apparent from the detailed description, which follows.

### BRIEF DESCRIPTION OF THE INVENTION

A system for searching and defining data in tree structures, according to the present invention, contains a block for analysis of data structure, in which the analysis of data structure takes place. These data are created by sources of data connected to the data structure analysis block, in this block a database is created, and data searching block, according to the criteria of the user. While the found data create a database for the structure of output data, which is updated in data update block, according to queries, defined in the output structure and data from the output database are transmitted to the data output, while the unit controlling the operation of the system is a control computer, which is operated by the user.

Favorably, the connected data sources are A/V streams or application for decoders.

In the method of searching and defining data in the tree structures, according to the present invention, the language of database queries is defined, adjusted to tree structures, which in recursive way allows accessing components, which compose the tree structure of data, where after initiating the search function the place of the start of the search is fetched, and next in case of when the components, in which the search should proceed, are defined, the path of these components is broken down into subcomponents, and when the first of them is set as active, the place of starting of the search is defined as a collection of results and for each result the subcomponents of components are checked subsequently in order to find the searched and defined components.

Favorably the checking of the subcomponents of components in order to find the searched and defined components starts from searching for places, which fulfill the conditions which are defined by the consecutive subcomponents of the searching range. Next is checked if the places, corresponding to the searched subcomponent were found. If not, the procedure ends its operation with an empty result. In opposite case, when such places are found, the collection of places is updated by exchanging places, which correspond to the previously processed component for the found places. Next a check is made, if all the subcomponents from the list were analyzed and if so, the current collection of places is a result, on the basis of which selected features of the found components are fetched. In opposite case, when there are subcomponents remaining for checking, the next subcomponents from the list are activated and search is made for next subcomponents until all the subcomponents are searched.

The properties, being searched for, of the components can be given in a form of a list, separated by commas (property_name1, property_name2, . . . ), optionally each property can appear in the result under a different , user defined name (output_name1), output_name2, . . . ).

Favorably, the query parameter at searching is the beginning_path used in order to limit the search to a specific part of the tree.

Favorably at searching the parameter searching_range is defined, which defines a set of places, where one should search for parameters, which fulfill the query criteria.

In case, when the procedure searching the tree does not find one of the places, defined by the searching_range parameter, it ends its operation with an empty result.

Favorably, searching and defining data is conducted in an audio/video stream in MPEG format, applied in digital television.

Favorably, a query is made, which allows to allocate to one branch of the tree a part or the whole information of another or many other branches of the structure, by creating from such information a local copy, which is not written as a physical data copy in the source database, and the connected data are automatically updated with the use of database queries.

Favorably, the query is executed by the user or is automatically updated.

Favorably a connection of the query with the elements of the tree is described with the use of markup language, especially XML.

A set of query results can be defined using the functionality of user's queries, where the user decides, which results will be considered.

The novel features, which are considered as characteristic for the invention are set forth in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

In the accompanying drawings one of the possible embodiments of the present invention is shown, where:

FIG. 1 is a block diagram of the system of searching and defining data;

FIG. 2 is an exemplary tree hierarchy;

FIG. 3 is an exemplary tree branch, where a query is executed;

FIG. 4 is an exemplary result of a query in a form of a table;

FIG. 5 is a definition of the service list descriptor;

FIG. 6 is a definition of the service list descriptor by means of a query;

FIG. 7 is a tree, for which the query from FIG. 5 is formed;

FIG. 8 shows functionality of user's queries;

FIG. 9 is a result of the action of user's query in a form of a tree; and

FIG. 10 is an algorithm of operation of the query.

### DESCRIPTION OF INVENTION AND PREFERRED EMBODIMENT

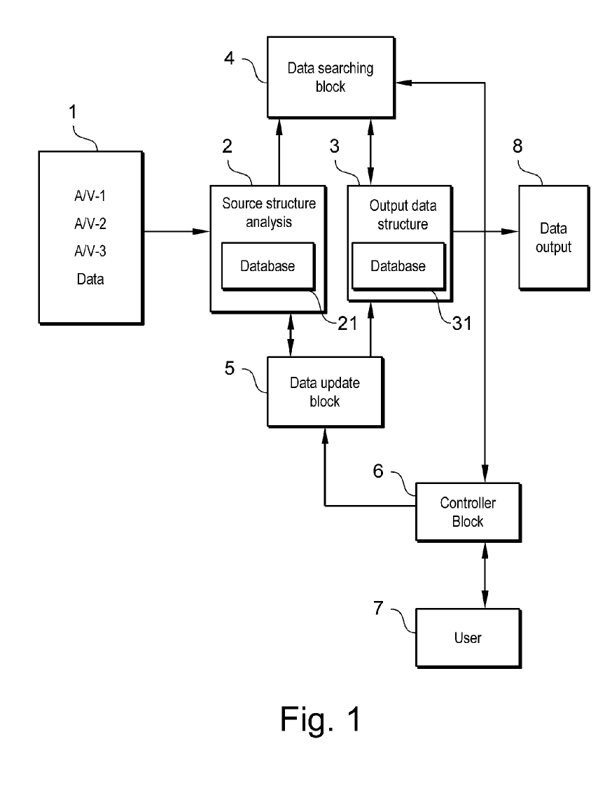

The first block, of the system for searching and defining data in tree structures, presented in FIG. 1 is the block 2 of analysis of the data structure, where the analysis of the data structure takes place, which is created by the connected data sources 1, for example A/V streams or applications for decoders. In the block 2 of analysis of the data structure a database 21 is created. Data are searched in the data searching block 4 according to the criteria of the user, and the searched data create an output database 31 having a structure 3 of output data. These are output data for which the searching and data update are made. The output database 31 is updated in the data update block 5 and it is made according to queries defined in the output data structure 3. Data from the output database 31 are transmitted to the data output 8. The unit, which controls the operation of the whole system is a controller block 6, for example a control computer, which is operated by the user 7.

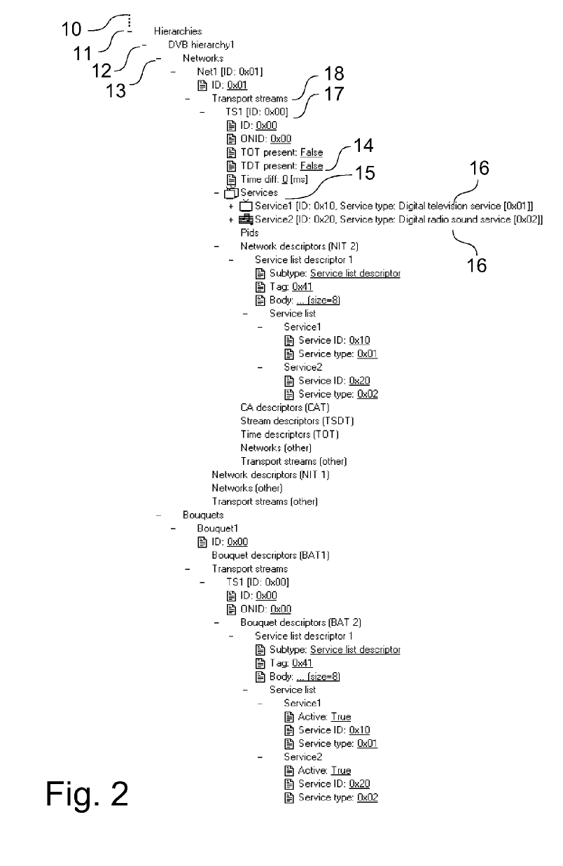

FIG. 2 illustrates an exemplary tree structure 10 with the main branch 11 called ‘Hierarchies’. Each element of the tree, which includes other nods is called a branch 12, 13, in other cases it is a “leaf” 14 of the tree. The branch of the tree can for example represent a component of the digital television data stream. The property, here called the “leaf” 14, of such component, called a branch, can be for example its identification number or name. Places, i.e. the locations of elements in the structure, are defined by means of paths. For example writing of the path “/Hierarchies/DVB hierarchy1/Networks” specifies the place, in which the component “Networks” is located.

The method according to the invention is applicable mainly in the broadcasting systems of digital television. For example, if the user wants to search all the identification numbers of digital streams of a given network, the system according to the invention gives a set of the branches of the network tree, which is represented by transport streams and the name of the field, which specifies identification numbers. Searching is conducted by means of the searching function SELECT after query is made by the user.

The general structure of the query is defined in the following way:

(1)SELECT property_name1 [INTO output_name1]
(2) [,property_name2 [INTO output_name2], ...]
(3)FROM beginning_path
(4)AT searching_range

The output properties, being searched for, of components may be given in a form of a list, separated by commas (property_name1, property_name2, . . . ). Optionally, each property can appear in the result under a different, user-defined name (output_name1, output_name2, . . . ). For example, the identification numbers ID of services of a given stream can as a result of the query appear under the name of ID_Services.

Names of properties can also be defined in form of paths, which is applicable at complex queries made on trees of digital television data streams, MPEG for example.

The next parameter of the query is the beginning_path. The results of each query, which includes this parameter, will be limited to a specific part of the tree of the network of digital television data streams. By means of this parameter one can define a few places in the tree of the network of data streams of digital television. For example, if the value of the field beginning_path indicates the A stream of the C network, only the components, belonging to a specific stream will be considered at searching.

The last parameter of the query is the searching_range. It defines the set of places in the tree structure, where elements, which fulfill the criteria of the query, should be searched. For example, if the query has a task of searching for all services of a given stream, then the parameter beginning_path indicates a branch of the tree, which defines this stream, for example “Services” 15 from FIG. 2, and the parameter searching_range defines the places, where the descriptions of services are located.

The value of the parameter searching_range is a set of names separated by the character “/”. Each name can define the name of the tree branch, the type or subtype of a branch. The value given in the square brackets [ ] is treated as a type, and the name given in the curly brackets { } as a subtype:
Transport streams/[Transport stream]/Services/{Service}

The above example defines the searching range as a path, indicating all nodes in the subtype {Service} 16 in the branch of the tree with the type “Services” 15, the superior branch of which is any branch of the type of {[Transport Stream]} 17, which is a subbranch of the branch with the name of “Transport Streams” 18.

A clause “WHERE” can be added to the above syntax, which defines parameters of the searched fields, for example PID>5.

The process of query is recursive. That is why for every iteration a temporary result is stored. If the procedure searching the tree does not find one of the places, defined by the parameter searching_range, it ends its operation with an empty result. The algorithm starts searching from the place defined by the parameter of beginning_path and next searches consecutively places defined by the path given in the parameter of the searching_range.

In the next example a query is described, which searches all the services in a given stream, and gives the current properties ‘ID’, ‘Service type’ and ‘Name’ in the result as ‘Service ID’, ‘Type of service’ and ‘Service Name’ respectively:

(1) SELECT ‘ID’ INTO ‘Service ID’, ‘Service type’ INTO
(2) ‘Type of service’, ‘../../ID’ INTO ‘Transport Stream ID’,
(3) ‘Name’ INTO ‘Service Name’
(4) FROM ‘.’
(5) AT ‘Services/{Service}’

The query starts searching from the currently selected branch of the tree ‘.’, it is for example “TS1” 17 from FIG. 2. One can also use the marking ‘..’ in order to start searching from the branch which is one level higher than the currently selected (the marking ‘../..’ means two levels higher), i.e. “Transport streams” 18 from FIG. 2.

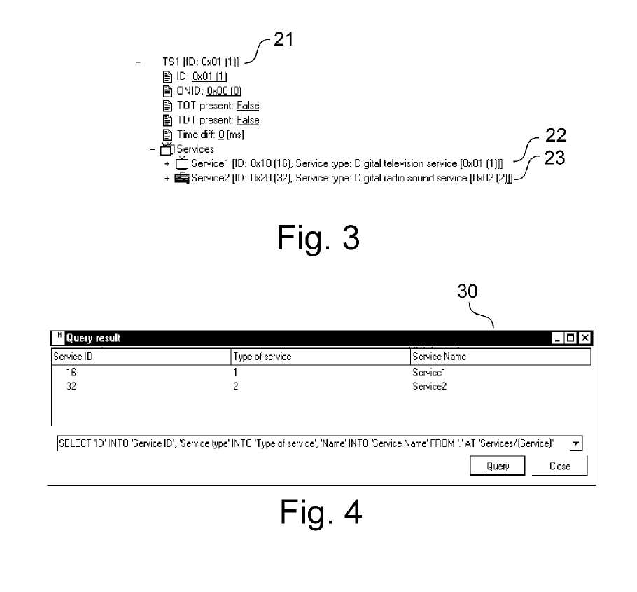

The result of searching was illustrated in FIG. 3 and FIG. 4. The stream “TS1” 21 comprises services: “Service1” 22 and “Service2” 23. As the result table 30 shows, “Service1” has identification number “16”, and “Service2” has identification number “32”.

The next application of the method according to the invention is the automatic update of data in the tree. It often happens that one set of data, for example a branch, appears many times in a given tree. In such case, in order to avoid unnecessary copying of data, and reduce their quantity at the same time, one can apply a mechanism of queries according to the present invention. Then, consecutive repetitions of data are defined as queries, which allow storing all other data one time in the whole tree. Moreover, possible modifications of data are made only in one place, which shortens the modification process considerably.

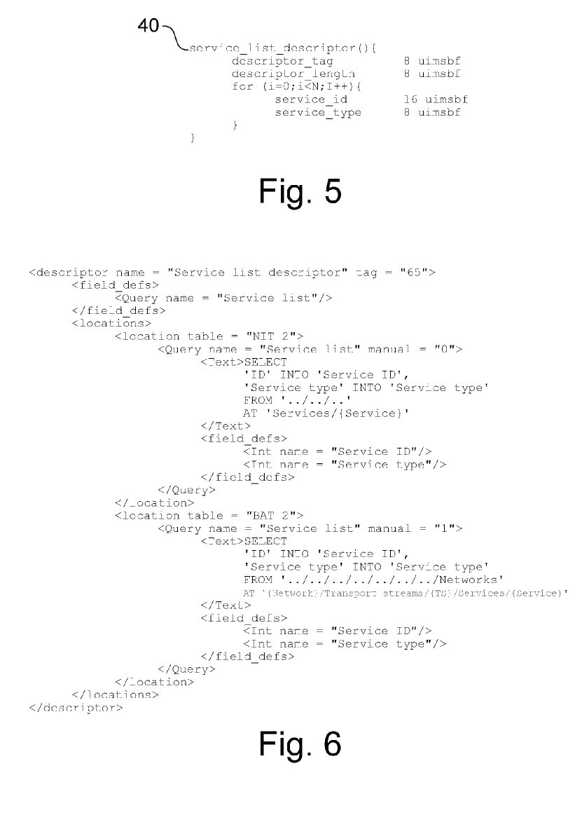

A special case, where one set of data appears many times in one tree is a list of descriptors of services of digital television and PSI/SI data (Program Specific Information/Service Information). For example a descriptor must include identifiers and types of all the services of a given stream. The number of services in a stream can change at any time. For example, a definition of the descriptor of the service 40 according to ETSI EN 300 468 standard v1.4.1. was illustrated in FIG. 5. In case of loops defined permanently, applied in typical tree structures, at each addition or deletion of the service one should at least change the number of iterations of the loop. In order to avoid a change of the number of iterations each time after changing the number of services, one should use the method according to the invention. Then, the content of the list can be refreshed automatically.

Data, defined with the use of the query are defined as a DATA BLOCK. The mechanism of connecting the query with the tree elements is described with the use of XML language, known from the current state of the art. Such description includes a definition of the query, the place of the tree, where one should send the result and definitions of the result fields. In case, when the list of results, for example a list of service descriptors, should not include all possible results, their set can be defined using the functionality of the user's queries, where the user decides, which results will be considered. It is required also that each query should have a unique name, because many queries can reefer to one place in the structure of the tree.

FIG. 6 illustrates a part of tree definition, where queries are applied. In the beginning of the definition the name of the query is defined.

(1) <field_defs>
(2) <Query name = “Service list”/>
(3) </field_defs>

Next, the places of the structure are specified, for which queries are defined. In the example, these are two places NIT2 and BAT2. Each of them has a separate definition of the query. Meanwhile, one should notice that the name of the query is the same in both cases. The query related to the place BAT2 uses the functionality of the user queries.

The definition of the query is specified in the following way:

(1) <Query name = “Service list” manual = “0”>
(2) <Text> SELECT
(3) ‘ID’ INTO ‘Service ID’,
(4) ‘Service type’ INTO ‘Service type’
(5) FROM ‘../../..’
(6) AT ‘Services/{Service}’
(7) </Text>
(8) <field_defs>
(9) <Int name = “Service ID”/>
(10) <Int name = “Service type”/>
(11) <field_defs>
(12) </Query>

The tag <field_defs> defines two properties of data, they are two integer numbers. These properties are only defined by name, because other, if they exist, are fetched from original data location. However, the user can define these properties, which causes overwriting of the source values. The values of the fields, which are copied automatically, are marked as read-only.

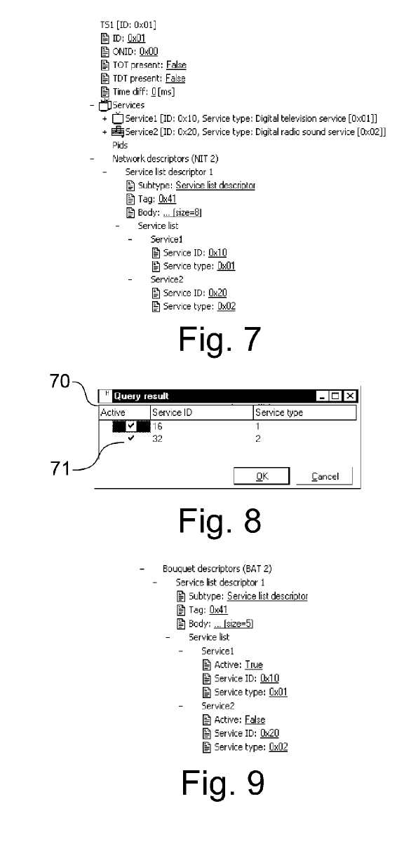

The tag <Text> defines the text of the query. Because the query is related to the descriptors from the NIT2 table, the search was started from the tree branch, which is three levels above, i.e. from the beginning of the definition of the given transport stream. The tree for this query was presented in FIG. 7.

Moreover a place of searching was defined, which is all the nodes with the subtype of {Service} of the branch ‘Services’.

The second, below given, query is related to location BAT2.

(1) <location table = “BAT”>
(2) <Query name = “Service list” manual = “1”>
(3) <Text> SELECT
(4) ‘ID’ INTO ‘Service ID’,
(5) ‘Service type’ INTO ‘Service type’
(6) FROM ‘../../../../../../../Networks’
(7) AT ‘{Network}/Transport
(8) streams/ {TS}/Services/{Service}
(9) </Text>
(10) <field_defs>
(11) <Int name = “Service ID”/>”
(12) <Int name = “Service type”/>”
(13) </field_defs>
(14) </Query>
(15) </location>

This query is very similar to the first one with the difference that the functionality of user's queries was applied here by setting the parameter manual to 1. After adding such descriptor to the tree structure, a query is executed, and results are presented to the user, who can narrow the list of the received results. The selection of results is not a single event, the user can, at any time, narrow or broaden the list of the monitored results. In case of queries of this type, each result has the ACTIVE 71 property, as given in FIG. 8 in the table 70, which decides about the validity of the result, i.e. if the data will be considered.

The queries can be executed one time, can be made by the user and can be automatically updated. Data searched by means of a query can create a new branch of the tree in the structure of output data, i.e. in effect ascribe new data to the output structure.

The result of applying the second query was presented in FIG. 9.

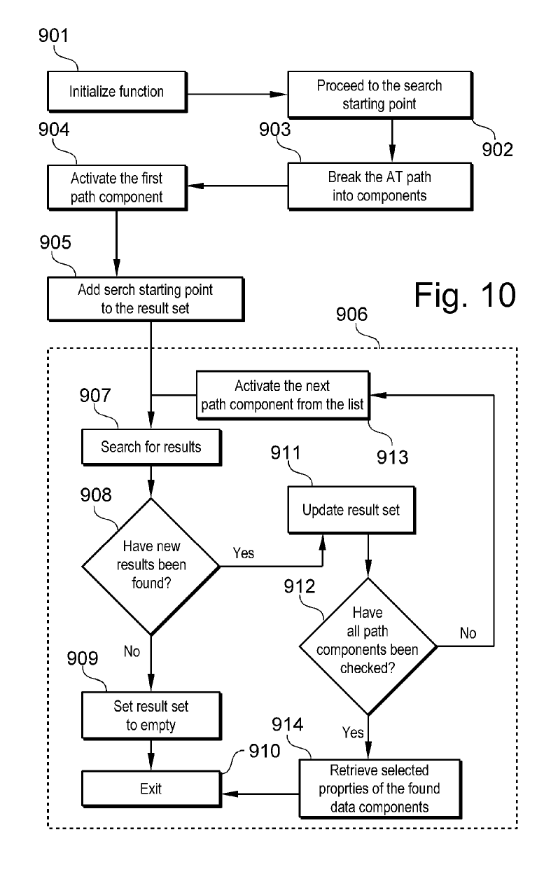

FIG. 10 presents a decision diagram, according to which a query is made. An exemplary query is: Select ‘PID’ FROM ‘../..’ AT ‘SERVICES/[SERVICE]/{AUDIO}, which has a defined range of searching at ‘SERVICES/[SERVICE]/{AUDIO}. The components of the searching range are SERVICES, [SERVICE] and {AUDIO}. Considering such components of the searching range, the elements of the tree with the name of ‘Services’ are searched subsequently. Next in the found ones, all the elements with the type of [SERVICE] are searched and in the found services, the elements are searched, with the subtype of {AUDIO}. The next subcomponents are analyzed from the left side according to the sequence of writing. The procedure starts with the initiation of the searching function in step 901. Next, in step 902, the place of starting the search is fetched (the part defined by the field FROM in the query, i.e. ‘../..’), it is a branch of the tree two levels higher than the current place. Let the current place be for example the descriptor in the location of NIT2 in FIG. 2 (in the real system this place depends on the requirements of the user or the control logic). From this place, the starting point (i.e. the place of starting the search) is two levels higher in the hierarchy, thus in the example from FIG. 2 it is TS1. Next in case, when the places are defined (by means of AT field), where one should search for the elements fulfilling the query criteria, the given path is split into components in step 903. In the exemplary query above, the AT field has the value of “Services/[Service]/{Audio}”, which will be split into three components:
Services
[Service]
{Audio}
   thus it defines the branch “Services”, contained in the place of starting the search (which was earlier found by means of FROM parameter), including a few (can be zero) branches of the type “Service”, which in turn include a few (can be zero) branches of the subtype AUDIO. If the parameter AT is not given, all the elements of the tree are considered below the specified place of starting the search. In the step 904 of the procedure the first subcomponent or the first subcomponent path is set (i.e. Services) as active, next the place of starting the search as the place for searching in the step 905 and for each result subsequently, recursively in the step 906 one searches for places defined by the parameter searching_range. The process of recurrence starts in the step 907 from searching for places, which meet the conditions, defined by the subsequent subcomponents of the searching range. Next, in step 908 it is checked if appropriate places corresponding to the current subcomponent were found. If not, for example there are no services in the given stream, the procedure ends its operation in step 910 with an empty result, which is reset in step 909. In the opposite case, when such places were found, the procedure moves to step 911, where the collection of places is updated by exchanging places, which are related to the previously processed component for places found in step 908. Next, in step 912 it is checked, if all the components from the list were analyzed. If it is so, the current collection of places is a result on the basis of which one can fetch in step 914 selected properties of the found components. In opposite case, when there are still subcomponents to be checked, the procedure moves to step 913, where the next subcomponent from the list is activated.

The preferred embodiment having been thus described, it will now be evident to those skilled in the art that further variation thereto may be contemplated. Such variations are not regarded as a departure from the invention, the true scope of the invention being set forth in the claims appended hereto.

1. A system for searching and defining data in tree structures comprising
data sources (1) composing a data structure;
a block (2) of analysis of the data sources having access to the data sources (1) composing the data structure;
a database (21) created in the block (2) of analysis of the data structure;
a data searching block (4) for searching the database (21) according to users criteria and for composing an output data structure (3) from data found according to the users criteria;
an output database (31) formed from found data in the output data structure (3);
a data update block (5) for updating the output database (31) according to queries defined in the output data structure (3);
a data output (8); and
a control computer for controlling operation of a system and operated by a user.

2. The system for searching and defining data, according to claim 1 wherein
the data sources (1) are A/V streams or applications of decoders.

3. A method of searching and defining data comprising the following steps:
defining language of database queries adjusted to tree structures and allowing in recursive way accessing to components creating a data tree structure;
fetching a place of starting a search after initiating a searching function;
splitting into subcomponent paths a path of the components when the components, in which the search should be made, are defined;
setting a first subcomponent path chosen from the component paths as active;
defining a place of starting the search as a collection of results;
checking each subcomponent path for each result of the results to find components to be searched and defined.

4. The method of searching and defining data according to claim 3 wherein the checking of each subcomponent path to find the searched and defined components is started from searching for places, which fulfill the conditions, defined by the subsequent subcomponent path of the searching range
and wherein the method further comprises the following step:
checking if the places corresponding to the searched subcomponent were found and if not the procedure ends with an empty result, while in the opposite case, when such places are found, the collection of places is updated by exchanging the places, which are related to the previously processed subcomponents with the found places and next it is checked if all the subcomponents from the list were analyzed and if it is so, the current collection of places is the result, on the basis of which selected properties of the found components are fetched and in the opposite case, when there are still remaining subcomponents for checking, the next subcomponent is activated from the list and searching is conducted for the next subcomponents until all the subcomponents are searched.

5. The method of searching and defining data according to claim 3 wherein the searched properties of component paths are given in form of a list, separated by commas (property_name1, property_name2, . . . ) and optionally each property appears in the result under a different, user defined name (output_name1, output_name2, . . . ).

6. The method of searching and defining data according to claim 3, wherein a parameter of the query at searching is beginning_path applied in order to limit the searching to the specific part of the tree.

7. The method of searching and defining data according to claim 3, wherein at searching the searching parameter searching_range is defined, which defines the set of places, in which a search for the elements fulfilling the query criteria shall be executed.

8. The method of searching and defining data according to claim 3, wherein if the procedure searching the tree does not find any of the places, defined by the parameter searching_range, it ends operation with an empty result.

9. The method of searching and defining data according to claim 3, wherein the searching and defining data is conducted in the audio/video stream in MPEG format, applied in digital television.

10. A method of searching data included in tree structures comprising the following step:
executing a query allowing to ascribe the whole information or a part of information of other or many other branches of the structure to one branch of the tree, by creating a local copy of such information, which is not recorded as a physical copy of data in the source database, and the linked data are updated automatically with the use of database queries.

11. The method of searching data included in tree structures according to claim 10, wherein queries are executed once by the user or they are automatically updated.

12. The method of searching data included in tree structures according to claim 10, wherein the link of the query with the elements of the tree is described with the use of the markup language, especially XML.

13. The method of searching data included in tree structures according to claim 10, wherein the result set of the query is defined using the functionality of the user's queries, where the user decides which results will be considered.

14. The method of searching data included in tree structures according to claim 10, wherein searching and defining data is conducted in the audio/video stream in MPEG format, applied in digital television.
